(19) United States
(12) Patent Application Publication
(10) Pub. No.: US 2012/0185321 A1
(43) Pub. Date: Jul. 19, 2012

(54) END-TO-END MULTI-VENDOR LOYALTY E-CARD SYSTEM

(76) Inventor: JAIDEEP LAL, OTTAWA (CA)

(21) Appl. No.: 13/352,165

(22) Filed: Jan. 17, 2012

Related U.S. Application Data
(60) Provisional application No. 61/433,367, filed on Jan. 17, 2011.

(51) Int. Cl. G06Q 30/02

(52) U.S. Cl. 705/14.28

(57) ABSTRACT

An end-to-end customer loyalty card system integrates a number of single corporate loyalty cards into a single loyalty card adaptable to smartphone applications. The system includes a point-of-sale terminal system for processing a customer loyalty card and a central system for controlling point-of-sale terminal systems.

### REFERENCE TO OTHER RELATED APPLICATIONS

This application claims the benefit of U.S. Provisional Patent Application No. 61/443,367 filed on Jan. 17, 2011 by the same inventor.

### FEDERAL SPONSORSHIP OF RESEARCH

N/A

### FIELD OF THE INVENTION

The invention relates to a customer loyalty card and devices associated therewith, such as a point-of-sale terminal system for processing a customer loyalty card and a central system for controlling point-of-sale terminal systems. Specifically this invention relates to an end-to-end multi-vendor loyalty e-card system.

### BACKGROUND TO THE INVENTION

Companies operating in retail business try to enhance customer loyalty by offering various customer loyalty cards. Each company issues its own card. A customer purchasing products and services from several companies may have to carry several loyalty cards in a wallet or purse. There is a continued need for a loyalty card system that is convenient to use, requires a single identification number and takes advantage of modern smartphone applications.

### SUMMARY OF THE INVENTION

One object of the invention is to provide a green loyalty program. Another object of the invention is to provide an end-to-end loyalty e-card system that uses a single e-card membership and identification number to track subscriptions to multiple vendors' loyalty programs.

Another object of the invention is to increase the convenience of loyalty card systems by using smartphone applications.

Yet another object of the invention is to integrate a smartphone application to a back-end server to display and manage the loyalty programs of multiple vendors.

### BRIEF DESCRIPTION OF THE DRAWINGS

FIG. 1 is a schematic of universal membership ID and loyalty programs of another embodiment of the invention.

FIG. 2 is a schematic of system portals and loyalty programs management of one embodiment of the invention.

FIG. 3 is a barcode image of one embodiment of the invention.

FIG. 4a is an image of a smartphone application allowing new users to self-register into the Green Loyalty Program of one embodiment of the invention.

FIG. 4b is an image of a smartphone application allowing a user to sign in used in one embodiment of the invention.

FIG. 4c is an image of a smartphone application displaying multiple barcodes for use in one embodiment of the invention.

### DETAILED DESCRIPTION OF THE INVENTION

The invention is called a Green Loyalty Program (GLP) and it is an end-to-end multi-vendor loyalty e-card system.

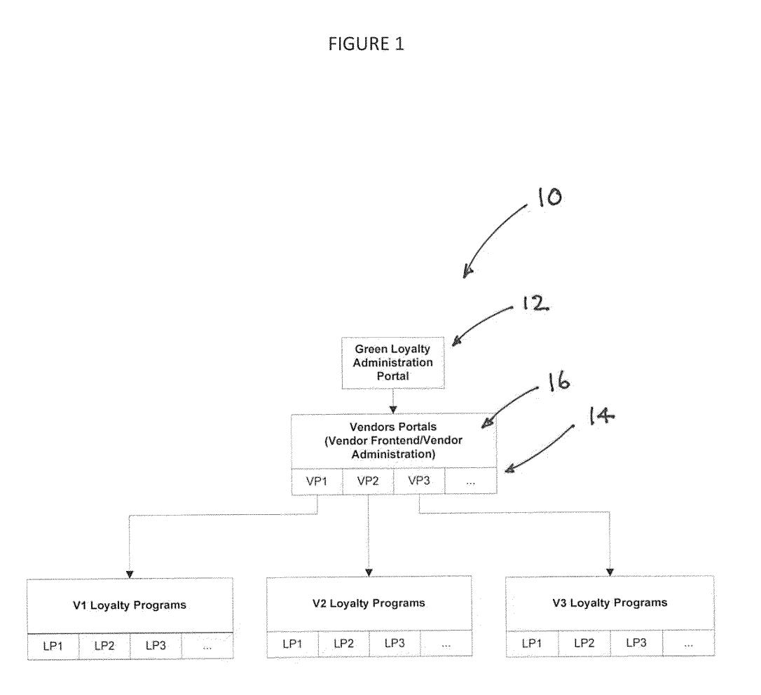

Referring to FIG. 1, the invention 10 comprises a single universal e-card membership ID number that tracks subscription to multiple vendors' loyalty programs. Store customers need only carry one membership ID to participate in multiple loyalty programs. Membership is made more convenient with the use of a smartphone app, which integrates to the backend server to display and manage account information. The account information is presented to the store clerk to collect and redeem points on point of sale transactions.

There are four browser-based web portals and two smartphone apps used as part of the system: a green loyalty administrative portal, a vendor administrative portal, a vendor frontend portal and a member portal, a smartphone app and a Blackberry™ app.

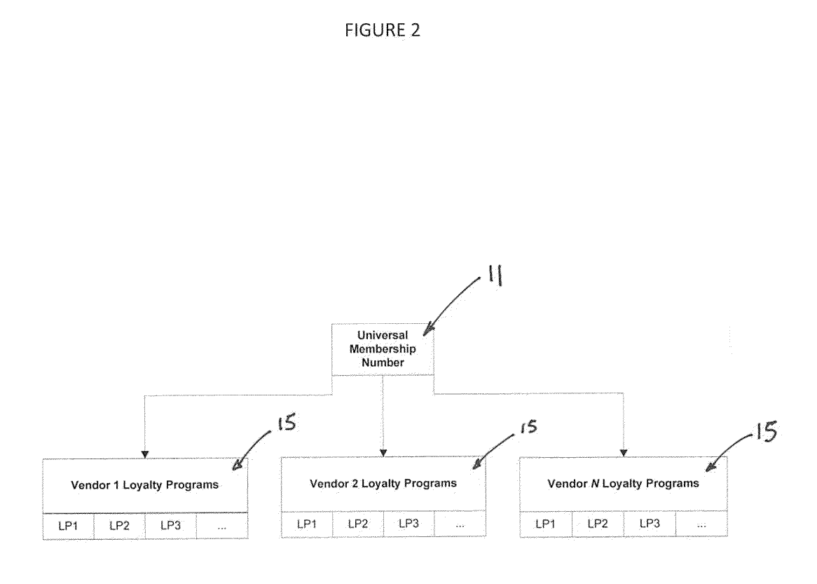

Referring to FIG. 2, the invention comprises a universal membership number 11 to track a variety of corporate loyalty programs 15. The administrative portal 12 comprises a web site used by the Green Loyalty company's system administrators for managing the vendor sites 14, e.g., managing vendor accounts, running reports, performing system administration, configuring system settings, etc. Vendors 14 are the businesses who agree to participate in the GLP operation promoting loyalty among their customers with cash-based incentives. Functions of this site include managing GLP administrators, managing vendor sites and managing platform settings.

The vendor administrative portal 16 comprises a web site used by vendor (e.g., store) managers for managing clerk accounts and loyalty programs. Access is given based on login ID, password, and vendor ID. Upon login the vendor administrator is presented with a dashboard displaying any security alerts levied by clerks and managers, and statistics such as total number of members, new members today, etc. Functions of this site include: manage account managers, manage clerk accounts, loyalty program administrative, charity management, vendor administrative reports and miscellaneous platform settings.

The vendor frontend portal 16 comprises a website used by store clerks at point-of-sale for activating new members, and performing various points-based transactions. Access is given based on correct login ID, password, and vendor ID. Upon login the clerk is presented with a membership look-up page for either membership ID (scanned by barcode reader or manually typed) or personal information to cross-reference. A new member is added automatically if the supplied ID is not found on the vendor's site. Upon successfully validating a membership ID, the clerk is presented with the member's dashboard displaying name, amount of points, any levied security alerts, a list of loyalty programs of which he is a member, and a list of other account functions, e.g., view, edit, delete, etc. If multiple loyalty programs exist, the clerk will ask the customer which loyalty program he would like to participate for the current point of sale transaction. A standard workflow has the clerk asking the customer if he would like to add or redeem points. Assuming the customer decides to add points, the clerk clicks the loyalty program from the list to bring up the Points Transactions screen displaying the Add Points page. The clerk completes the transaction using existing point-of-sale equipment, e.g., scanner, cash register, etc. after which the net cost of the order is read by the clerk and manually keyed into the “Enter Transaction Amount” field and submitted to the system. The account balance is updated and a printable receipt is displayed on screen. The clerk may perform other point-based transactions or simply close the customer record and return to the membership look-up page. Functions of this site include: look-up/join account membership, view/edit membership account, add points, redeem points, void points transaction, transfer points and points receipt.

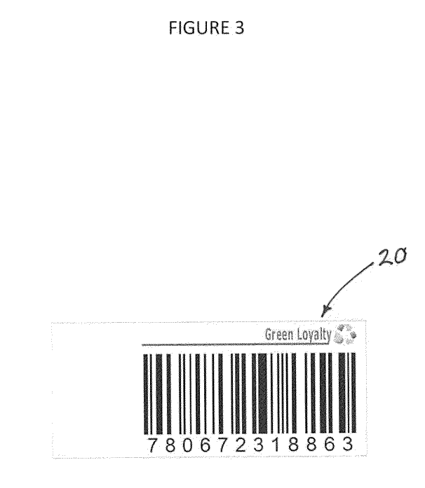

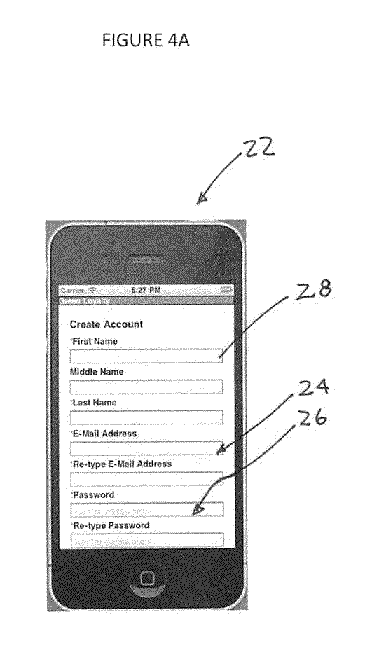

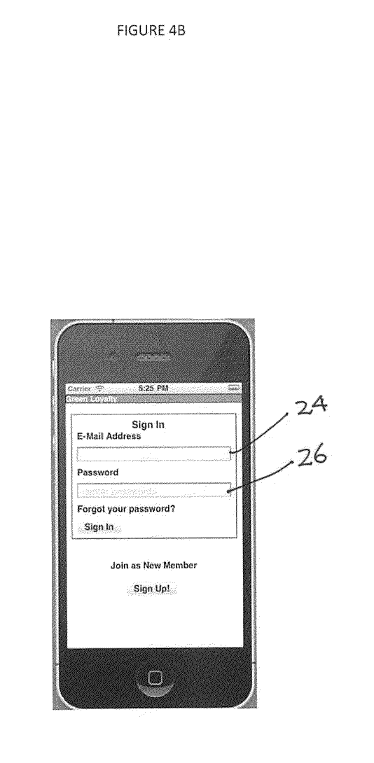

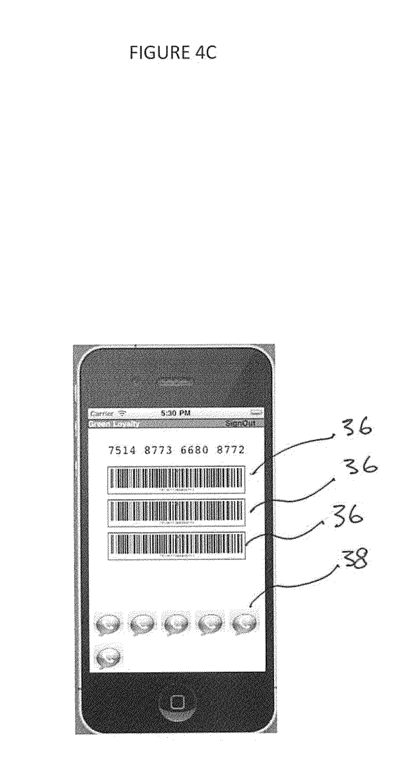

Referring to FIGS. 4a to 4c, the member portal 22 is a website used by vendors' customers to monitor points balance and other member activities. Access is given based on correctly supplied e-mail address 24 and password 26. There are various account services for convenience such as creating a new account, retrieving a forgotten email address 30, and retrieving a forgotten password. Creating an account is the first step to obtaining a membership ID and begins by entering one's name 28, e-mail address 24, and password 26 along with accepting the terms of use and privacy statement. A validation e-mail is sent to the user to verify that the e-mail address is correct. Upon clicking the activation link, the user is presented with a form to enter some additional personal information, such as gender, age, home address, and phone numbers. Upon successful login, if the user is a member of multiple loyalty programs 36 each are listed with company logo 38, name, and points balance. After clicking a link, the membership summary dashboard is displayed. Here the user sees his points balance and a list of recent purchases. Functions of this site include: purchase history where a transaction history for the previous four months may be viewed, point donation where the member can donate points to charities selected from a list of charities and enter the number of points to donate, link accounts where the member can allow family members to pool points into a common point balance, retrieve barcode [FIG. 3, Item 20] for users who don't have a smartphone or data service but have a hi-resolution screen on their cell phone barcode images are available in different screen orientations. Setting this image as the wallpaper will conveniently allow the user to present the bar code to the clerk at the point of sale.

Green Loyalty iPhone Apps [FIGS. 4a to 4C] are smartphone apps allowing new users to self-register as a Green Loyalty member. It displays a barcode 38 (containing the membership ID) that is presented to a store clerk at point of sale for membership activation and collecting/redeeming points.

What is claimed is:

1. An end-to-end multi-vendor loyalty e-card system comprising:
a. A first Internet portal comprising an administrative portal comprising first computer processor and a first software platform program for generating a suitable first graphic user interface;
b. A second Internet portal linked to said first internet portal, wherein said second internet portal comprises vendor administrative portal comprising a second computer microprocessor and a second software program for generating a suitable second graphic user interface;
c. A third internet portal linked to said second internet portal and the first internet portal, said third Internet portal comprises a vendor frontend portal comprising a third computer processor and a third software program for generating a suitable third graphic user interface; and,
d. A fourth internet portal linked to the first, second and said third internet portals, said fourth internet portal comprising a member portal comprising a fourth computer processor and a fourth software program for generating a suitable fourth graphic user interface.

2. The system of claim 1 wherein the first internet portal first graphic user interface provides interactive functionality between a first system administrator and the system for managing the following functions: management of vendor accounts, generating running reports, performing system administration and, configuration system settings.

3. The system of claim 1 wherein the second internet portal second graphic user interface provides interactive functionality between a first vendor and the system for managing the following functions: managing clerk accounts, managing account managers, loyalty program administration, charity management, vendor administrative reports and platform settings.

4. The system of claim 1 wherein the third Internet portal third graphic user interface provides interactive functionality between a point-of-sale terminal and the system for managing the following functions: look-up and join account membership, view and edit account membership, add points, redeem points, void points transaction, transfer points and provide points receipts.

5. The system of claim 1 wherein the fourth Internet portal fourth graphic user interface provides interactive functionality between a loyalty program member and the system for managing the following functions: monitoring points balance, view transaction history, donate points to charities, link accounts between family members and retrieve a barcode.

6. The system of claim 1 further including a smartphone application having a suitable fifth graphic user interface for subscribing to the system.

7. The system of claim 6 wherein said smartphone application comprises a system registration window comprising a suitable number of data fields for adequately identifying a new member.

8. The system of claim 7 wherein the smartphone application further comprise a log-in window so that said new member can access the system and wherein said log-in window requires a member identity and password as prerequisites to system access.

9. The system of claim 8 wherein the smartphone application further comprises a window displaying at least one barcode associated with an at least one loyalty card.

10. The system of claim 1 further comprising a cell phone application wherein a single barcode is displayed to a point-of-sale vendor.
